(19) United States
(12) Patent Application Publication
(10) Pub. No.: US 2010/0149905 A1
(43) Pub. Date: Jun. 17, 2010

(54) Multi-chamber mixing cup

(76) Inventor: Sébastien Lucien Fily, Gaillard (FR)

Correspondence Address: BAYER HEALTHCARE LLC;CONSUMER CARE DIVISION, 36 COLUMBIA ROAD, MORRISTOWN, NJ, 07962, US

(21) Appl. No.: 12/589,137

(22) Filed: Oct. 19, 2009

(30) Foreign Application Priority Data
Apr. 19, 2007 (EP) 07290484.0

(51) Int. Cl. B01F 13/00

(52) U.S. Cl. 366/130

(57) ABSTRACT

A multi-chamber mixing cup having: (a) a pot with a base, a circumferential wall, and an axis extending upwards from the base towards an open top, and (b) a mixing member adapted to be placed pivotably and removably on the axis. The mixing member has at least two blades extending radially from the axis, and each of said blades may be brought into contact with the circumferential wall when the blades are aligned in at least one rotary position of the mixing member around the axis, thereby defining at least two mixing chambers within the mixing cup.

### BACKGROUND OF THE INVENTION

1. Field of the Invention

This invention relates a cup for the mixing and intake of two or more previously separated fluids or semi-solid materials such as liquids and gels.

2. Description of Related Art

Many beneficial medicines and nutritional supplements are available in liquid or flowable form, including solutions, suspensions, gels, pastes, and other liquid or semi-liquid forms. Many of these medicines and nutritional supplements, however, are not stable for long periods of time in liquid or flowable form, especially as part of a mixture or blend of medicinal or nutritional supplements. Not only may the medicine or nutritional supplement itself have limited stability in a liquid or gel formulation, but individual ingredients of combinations or mixtures of medicines or nutritional supplements that should preferably be administered substantially simultaneously can be incompatible in the sense that the ingredients can interact over time to reduce the effectiveness of the mixture by degrading one or more of the ingredients.

One solution to this problem is simply to administer each medicine or nutritional ingredient sequentially. This method, however, requires two or more containers if two or more medicines or nutritional supplements are to be administered. Patient compliance can be adversely affected if one container or another is misplaced or if the supply of one medicine or nutritional supplement runs out before another. Sequential administration does not help when only a single medicine or nutritional supplement is to be administered that is vulnerable to degradation in liquid or flowable form.

A better solution to the problems posed by liquid and flowable medicines and nutritional supplements is to store medicines and nutritional supplements as separate ingredients and to mix them together directly before administration.

One such approach is shown in French patent 2,599,337 to Leguen, published Dec. 4, 1987. This patent discloses a container for mixing two liquids comprising a pot for receiving a first liquid and a screw-on lid. Between the pot and the lid there is a partition closed by a perforated wall for receiving a second liquid. The lower part of the lid can fit the partition and comprises a perforating punch. When the lid is screwed in, the perforating punch pushed through partition and allows for mixing of the liquids. The container is reported to be suitable for the preparation of glue. The container disclosed in French patent 2,599,337 is designed so that the volume for receiving the second liquid is much smaller than the volume for receiving the first liquid and so the container is not suited for mixing approximately equal amounts of liquids or flowable material. The design also does not allow oral administration of the mixture directly from the container.

Other conventional approaches include containers that provide for side-by-side dispensing of products such as toothpastes. These containers can be used to dispense “striped” toothpaste made up of ribbons of brightly colored material along the length of the extruded dentifrice. Many containers are also known that provide for direct side-by-side dispensing of aqueous solutions as mouthwashes or household cleaning materials. Neither the known dentifrice dispensers nor the side-by-side aqueous dispensers are equipped to blend the dispensed materials, other than simple blending of aqueous cleaning materials on the surface to be cleaned or blending of dentifrice materials by the action of the toothbrush during brushing.

Accordingly, a need remains in the art for a container capable of storing materials, particularly medicine and nutritional supplements that can be mixed upon dispensing and that can thereafter be administered in a convenient manner.

### SUMMARY OF THE INVENTION

The principal object of the invention therefore is to provide a container capable of storing more than one material, particularly medicine and nutritional supplements that can be mixed upon dispensing and that can thereafter be administered in a convenient manner.

Another object of the invention is to provide a container capable of mixing more than two materials particularly medicine and nutritional supplements that can be mixed upon dispensing and that can thereafter be administered in a convenient manner.

Yet another object of the invention is to provide a convenient dispenser that allows administration of multiple medicines or nutritional supplements that are mutually incompatible in that one or more of the medicines or nutritional supplements is adversely affected by exposure to another medicine or nutritional supplement or to a carrier, solvent or liquid or flowable vehicle for delivering such medicines or nutritional supplements.

Additional objects and advantages of the invention will be set forth in part in the description that follows, and in part will be obvious from this description, or may be learned by practice of the invention. The objects and advantages of the invention may be realized and attained by means of the instrumentalities and combinations particularly pointed out in the appended claims.

To achieve the foregoing objects and in accordance with the purpose of the invention, as embodied and broadly described herein, the invention provides a multi-chamber mixing cup comprising a pot having a base, a circumferential wall and an open top, with an axis extending from the center of the base towards the open top, a mixing member adapted to be placed pivotably and removably on the axis. The mixing member has several blades extending radially from its rotary axis. The radial extension and shape of the blades are such that the blades can be joined tightly to the circumferential wall in at least one rotary position thus forming individual mixing chambers between each pair of blades and a segment of the circumferential wall.

Further to achieve the foregoing objects and in accordance with the purpose of the invention, the invention further comprises a bottle that is adapted to cooperate with the multi-chamber mixing cup. The bottle holds at least two ingredients in separate chambers and may employ the multi-chamber mixing cup as a lid.

Other objects and advantages of this invention will become apparent from the following descriptions and are set forth, by way of illustration and example, in certain examples set forth herein.

### BRIEF DESCRIPTION OF THE DRAWINGS

FIG. 1 shows a perspective view of the multi-chamber mixing cup

FIG. 2 shows a side view of the multi-chamber mixing cup

FIG. 3 shows a top view of the multi-chamber mixing cup

FIG. 4 shows a perspective view of a mixing member with two blades

FIG. 5 shows a procedure for using the multi-chamber mixing cup

### DETAILED DESCRIPTION OF THE INVENTION

Reference will now be made to the presently preferred embodiments of the invention.

The multi-chamber mixing cup comprises a pot having a base, a circumferential wall and an open top. An axis extends from the center of the base towards the open top. A mixing member is adapted to be placed pivotably and removably on the axis. The mixing member has several blades extending radially from the rotary axis of the mixing member. The radial extension and shape of the blades is such that the blades can be joined tightly to the circumferential wall in at least one rotary position thus forming individual mixing chambers between each two of the blades and a segment of the circumferential wall.

Preferably the mixing member has two, or more, preferably three, four, five or six, blades and the pot has a circular base or an n-fold symmetric base, where n is the number of blades, to provide for mixing a plurality of substances.

In a very preferred embodiment the pot has an oval base and the mixing member has two blades.

In one embodiment of the invention the volume of all mixing chambers is equal and in another embodiment, the volume of at least one mixing chamber is different from the volume of one or more of the other mixing chambers.

The circumferential wall can have lugs on its inside extending from the base towards the open top of the pot for joining the blades and the circumferential wall tightly in the at least one rotary position. The number of lugs is preferably equal to the number of blades of the mixing member.

The circumferential wall can have marked or embossed in the area of each mixing chamber a graduation for dosing the liquid, flowable material or gel to be filled in the respective chamber or a pictogram or written information indicating, i.e., the type of liquid, flowable material or gel to be filled in the respective area of the mixing chamber or the proper volume of each ingredient appropriate for administration.

The multi-chamber mixing cup can be used by placing the mixing member on the axis in the center of the base. If necessary the mixing member may then be turned so that each blade comes into tight connection with the circumferential wall and the lugs (if present) respectively. A predetermined amount of a different liquid or other flowable material or gel is then charged into each mixing chamber. Subsequently the mixing member is twisted to allow each liquid, flowable material or gel to come into contact with the other. Preferably, the mixing member is rotated one or more times in clockwise and counterclockwise direction to assist in mixing the different liquids, flowable materials and gels. Then the mixing member is removed and the mixture can be administered, either orally by sipping directly from the pot or topically or in any other suitable manner.

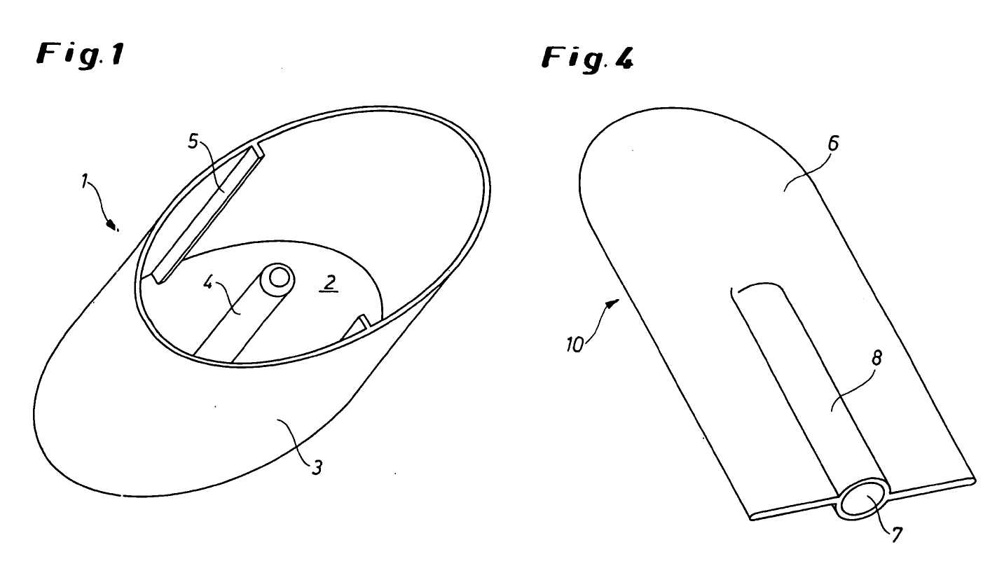

FIG. 1 shows a multi-chamber mixing cup in accordance with the invention. The mixing cup 1 defines a pot having an oval base 2, a circumferential wall 3 and an open top. An axis 4 extends from the center of the base 2 towards the open top. The axis may be hollow or filled. The circumferential wall 3 has two lugs 5 on its inside extending from the base 2 towards the open top of the pot.

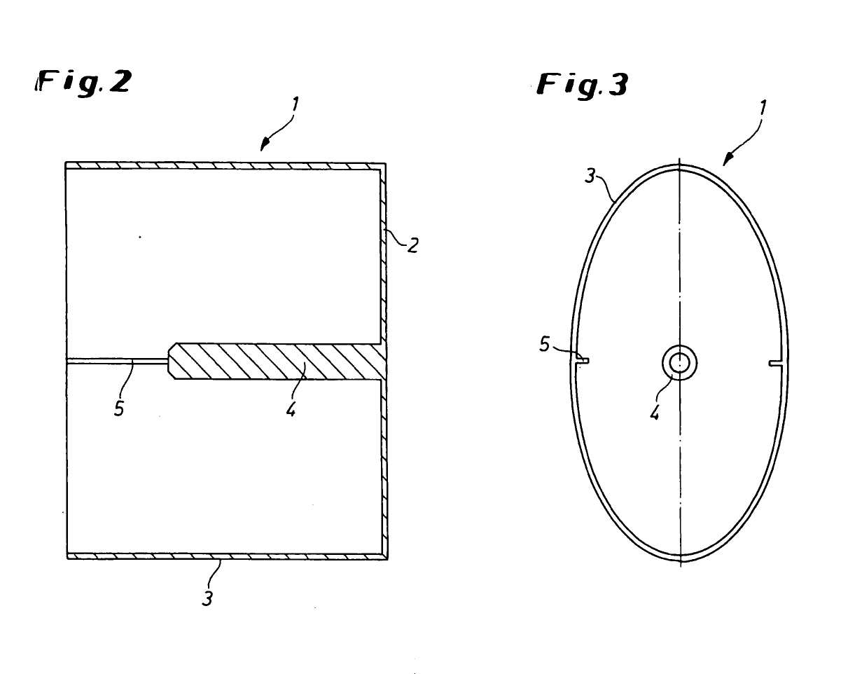

FIGS. 2 and 3 show the same multi-chamber mixing cup 1 as in FIG. 1 but from side and top views respectively.

FIG. 4 shows a mixing member 10 adapted to cooperate with the mixing cup 1 to form mixing chambers. The mixing member has two blades 6, which in FIG. 4 are regions of a larger single blade extending radially from the rotary axis of the mixing member 10. Even though the blades 6 may be formed from a unitary member, as used herein, the term blade is intended to refer to the structure extending outward from tubular broadening 8 to engage circumferential wall 3 as described herein. The interior of tubular broadening 8 is hollow, thereby forming opening 7 which extends partially through the mixing member 10. The mixing member 10 is adapted to be placed pivotably and removably on the mixing cup by inserting axis 4 of the multi-chamber mixing cup 1 (FIG. 1, 2 or 3) into the opening 7 of the mixing member 10. The radial extension and shape of the blades 6 is such that the blades 6 can be joined tightly to the circumferential wall 3 in at least one rotary position thus forming two individual mixing chambers between the two blades 6 and the according segments of the circumferential wall 3. for joining the blades 6 of the mixing member 10 (FIG. 4) and the circumferential wall 3 tightly in the at least one rotary position. In a preferred embodiment of the invention, the mixing chambers are defined when the blades 6 of the mixing member 10 are disposed against the lugs 5 of the mixing cup 1.

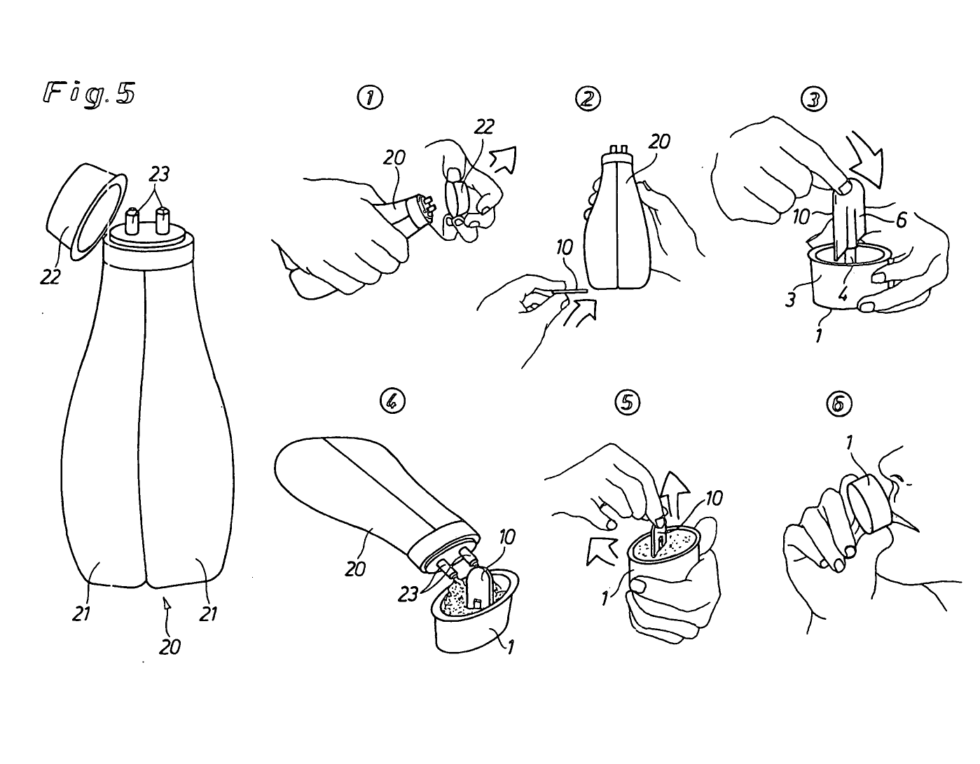

FIG. 5 shows a procedure for using the multi-chamber mixing cup. A bottle 20 having two compartments 21 filled with liquid or flowable formulations such as a gel. The formulations preferably contain different medicines or nutritional supplements. The bottle has a cap with two outlets 23, one for each compartment 21, and a lid 22. In a preferred embodiment of the invention, lid 22 may also be mixing cup 1 as shown in FIG. 1.

In accordance with the invention, the lid 22 may be removed from bottle 20 to expose outlets 23 as shown in FIG. 5, subfigure 1.

After opening, the mixing member 10 may be obtained. In a preferred embodiment shown in FIG. 5, subfigure 2, the mixing member 10 may be releasably attached to bottle 20 using conventional means known in the art.

The mixing member 10 may be inserted into mixing cup 1 (which may also preferably be lid 22) as shown in FIG. 5, subfigure 3. The mixing member 10 may be fitted over axis 4 and slid down to secure it against circumferential wall 3. A secure fit is preferred between the mixing member 10 and the mixing cup 1 to protect against the possibility of rapid degradation of the ingredients upon exposure to the other ingredients, those skilled in the art will recognize that a perfect fit is not a mandatory feature of the invention.

As shown in FIG. 5, subfigure 4, the two liquid or flowable ingredients, which are kept separately in compartments 21, may be poured out into the separate mixing chambers of the mixing cup 1. In a preferred embodiment of the invention, the outlets 23 of bottle 20 may be disposed so that each outlet feeds a separate material, stored in compartments 21, into the separate defined zones of the mixing cup 1.

When the combined ingredients are ready for administration, the mixing member 10 may be twisted in a clockwise or counter clockwise direction to expose the separate ingredients to each other. In a preferred embodiment of the invention, the mixing member 10 is rotated first in one direction and then in another to provide mechanical agitation to assist in rapid mixing of the ingredients.

When mixing is complete, the mixing member 10 may be withdrawn from the mixing cup 1.

FIG. 5, subfigure 6, shows that the mixed ingredients may be consumed directly from the mixing cup 1. The mixed ingredients may also be applied topically or in any other known manner of administration.

The foregoing description of the invention has been presented for purposes of illustration and description. It is not intended to be exhaustive or to limit the invention to the precise form disclosed, and modifications and variations are possible in light of the above teachings or may be acquired from practice of the invention.

What is claimed is:

1. A multi-chamber mixing cup comprising: (a) a pot comprising a base, a circumferential wall, and an axis extending upwards from the base, and (b) a mixing member adapted to be placed pivotably and removably on said axis, said mixing member comprising at least two blades extending radially from said axis, wherein each of said blades may be brought into contact with said circumferential wall when said blades are aligned in at least one rotary position of said mixing member around said axis, thereby defining at least two mixing chambers within said mixing cup.

2. The multi-chamber mixing cup of claim 1, wherein said axis extends upward from a region substantially in the center of said base.

3. The multi-chamber mixing cup of claim 1, wherein said mixing member comprises a plurality of blades.

4. The multi-chamber mixing cup of claim 4, wherein said base comprises an n-fold symmetric base, where n is the number of said blades.

5. The multi-chamber mixing cup of claim 1, wherein said base is oval and said mixing member comprises two blades.

6. The multi-chamber mixing cup of claim 1, wherein the volume of all said mixing chambers is substantially equal.

7. The multi-chamber mixing cup of claim 1, wherein the volume of at least one mixing chamber is different from the volume of one or more of the other of said mixing chambers.

8. The multi-chamber mixing cup of claim 1, wherein the circumferential wall comprises written information or a pictogram within each mixing chamber.

9. The multi-chamber mixing cup of claim 1, wherein said circumferential wall comprises at least two lugs on its interior face extending upward from said base

10. The multi-chamber mixing cup of claim 9, wherein the number of lugs is equal to the number of said blades.

11. A method of administering at least two materials using the multi-chamber mixing cup of claim 1, comprising the steps of: (a) placing said mixing member on said axis such that each blade comes into connection with said circumferential wall; (b) filling each material into an individual mixing chamber formed between said blades and said circumferential wall; pivoting said mixing member thereby mixing said materials; removing said mixing member from said axis; and administering said materials directly from said multi-chamber mixing cup.
